(19) United States
(12) Patent Application Publication
(10) Pub. No.: US 2019/0174071 A1
(43) Pub. Date: Jun. 6, 2019

(54) Device, Method and Computer Program Product for Inspecting Motor Vehicles

(71) Applicant: DVS GmbH & Co. KG, Passau (DE)

(72) Inventor: Bernhard WASNER, Ortenburg (DE)

(21) Appl. No.: 16/269,164

(22) Filed: Feb. 6, 2019

Related U.S. Application Data
(63) Continuation of application No. PCT/IB2017/055055, filed on Aug. 22, 2017.

(30) Foreign Application Priority Data
Aug. 24, 2016 (DE) 10 2016 115 698.1
Aug. 24, 2016 (DE) 20 2016 105 450.8

(51) Int. Cl. H04N 5/247; H04N 5/225; G06T 7/00; G01N 21/88; G01N 21/95; G01M 17/007

(52) U.S. Cl. CPC H04N 5/247; H04N 5/2253; H04N 5/2256; G06T 2207/30252; G01N 21/8806; G01N 21/9515; G01M 17/007; G06T 7/001

(57) ABSTRACT

A device, a method and a computer program product for inspecting motor vehicles utilize a plurality of image capturing devices arranged in several groups in the device. The motor vehicle passes through the device at a defined speed or the vehicle comes to a standstill in the device. Images of the individual sides of the motor vehicle are captured with the plurality of image capturing devices. The image acquisition occurs with several image capturing devices divided into several groups. A first group serves to capture images of a top side, a second group serves to capture images of an underside, a third group serves to capture images of a front side, a fourth group serves to capture images of a rear side, a fifth group serves to capture images of a left side, and a sixth group serves to capture images of a right side of the motor vehicle.

### RELATED APPLICATIONS

This Application is a Continuation application of International Application PCT/IB2017/055055, filed on Aug. 22, 2017, which in turn claims priority to German Patent Applications DE 20 2016 105 450.8, filed Aug. 24, 2016 and DE 10 2016 115 698.1, filed Aug. 24, 2016, all of which are incorporated herein by reference in their entirety.

### FIELD OF THE INVENTION

The invention relates to a device for inspecting motor vehicles. For this purpose, at least a plurality of image capturing devices are provided.

Furthermore, the invention relates to a method for inspecting motor vehicles.

In addition, the invention also relates to a computer program product. The computer program product is provided on a non-transitory and computer-readable medium. A computer for a device for inspecting motor vehicles, in conjunction with the device, causes data to be obtained from the motor vehicle to be inspected.

### BACKGROUND OF THE INVENTION

German patent application DE 10 2009 016 498.7 discloses a method and a device for determining the tread (tread) depth of a vehicle tire. To determine the tread depth of the vehicle tire, the tire is mounted on the vehicle, so that the tire rolls over a measuring station, or is parked on it. The tread of the tire is optically scanned on at least one measurement line transverse to the rolling direction of the tire, whereby a fan of beams originating from a light source is reflected on the tire surface and a signal of the reflected fan of beams is received by a sensor. The signal of the reflected fan of beams is evaluated by means of a triangulation method.

European patent EP 1 600 351 B1 discloses a method and a system for detecting defects and/or hazardous conditions regarding passing trains. The defects and/or hazardous conditions comprise, for example, shifted loads, overheating, failures or incipient failures in axle bearings, overheating of the wheels and brakes, overheating of vehicle body parts, and fire on board. For this purpose, a plurality of sensors and instruments are provided for at least one of the passing rail vehicles. The measurement data, the construction model, vehicle-specific information and data are electronically retrieved from a database and fed to a calculation. Defects and/or hazardous conditions of the rail vehicle are indicated by means of an alarm signal.

European patent EP 0 548 425 B1 discloses an electronic accident estimating system. Electronic images of accidented vehicles are recorded by an estimator. These images are then imported to a computer by using a color video digitizer. The images provide visual evidence to support the estimated accident damage.

U.S. Patent Application US 2009/244284 discloses a tire type determination method. For this purpose, a surface image of a tread portion of a tire is captured, the tire being mounted to a vehicle. The image information is extracted from the surface image of the tread portion, and a tire type is determined by checking the image information against registered information.

U.S. Patent Application US 2015/0287130 discloses a system and a method for capturing and storing images, which determine the state of a motor vehicle at two different times. With the system and the method, for example, the state of a rental vehicle can be determined at two different times. Damages are recorded and stored in order to be available for review and/or comparison with sooner or later captured images.

Japanese Patent Application JP 2014-081356 discloses a device for visual inspection. The device is configured such that a constant distance is always maintained between a camera and a surface to be examined While a vehicle is moved by a conveyor belt, the cameras inspect the coating surface for surface defects. By means of image processing, the defects are extracted from the recorded image information.

German patent application DE 10 2014 014 005 A1 discloses a device for recording and documenting an actual state of a vehicle with a camera device. The camera device is installed in a capturing stand having a stand location for the vehicle. At least one electronic camera is provided for each side of the vehicle to be captured, the data outputs of all the cameras being connected to a data processing device. The capturing stand has a base, in which a camera assigned to the underside of the vehicle is arranged. The image acquisition of the different sides of the vehicle is carried out when the vehicle is stationary.

British patent application GB 2500716 discloses a device apparatus for generating images of a motor vehicle. The stand for the image acquisition may be provided with a lighting means and a device for detecting the identification of the vehicle.

US patent application US 2007/0040911 A1 discloses a system for inspecting the underside (undercarriage) of a vehicle. For this purpose, an image capturing device is provided below the travel path of a vehicle.

US patent application US 2006/0114531 A1 discloses a system and a method for the automated inspection and analysis of motor vehicles. In an inspection station, images of the vehicle are captured. For this purpose, a plurality of cameras is provided. The captured image data of the vehicle are compared with stored image data of the vehicle.

US patent application US 2011/0128381 A1 discloses a quick pass entrance or exit control for motor vehicles. The identification of the driver and the motor vehicle is automatically determined. For example, an RFID reading device for reading the chassis number of the vehicle is provided. Furthermore, a plurality of cameras are provided with which, for example, the front or rear license plate, the driver, etc. are detected.

US patent application US 2008/0183535 A1 discloses a system and method for automatic inspection and analysis of rental cars. The data collected from the rental cars comprise, among others, photos of the rental cars.

### SUMMARY OF THE INVENTION

An object of the invention is to provide a device for standardized inspection of motor vehicles, with which it is possible to at least largely automatically detect and document the optical state of a motor vehicle and possibly output messages, if the state between two successive inspections of the same motor vehicle has changed.

The object is solved by a device for inspecting motor vehicles, comprising:

a bottom plate;

a housing composed of a frame, mounted on the bottom plate;

a plurality of image capturing devices mounted to the frame of the housing and being divided into a plurality of groups and being at least arranged such that a top side, a front side, a rear side, a left side, and a right side of the motor vehicle are imaged; and

at least one lighting means arranged in the housing with respect to the image capturing devices such that standardized illumination conditions for the motor vehicles prevail;

first guide rails mounted on the bottom plate, so that they are arranged on both sides of an entrance of the housing; and

second guide rails mounted on the bottom plate), so that they are arranged on both sides of an exit of the housing, wherein the first and second guide rails forming a lateral boundary of the device in order to center the motor vehicle in the housing and to position the motor vehicle with respect to the image recording devices.

A further object of the invention is to provide a method for the standardized inspection of motor vehicles with which it is largely possible to detect, document and possibly report the optical state of a motor vehicle.

This object is solved by a method a method for inspecting motor vehicles comprising the following steps:

checking an identification of the motor vehicle to be inspected by means of an entrance control and releasing access a housing into the device when the motor vehicle is registered for access;

centering the motor vehicle substantially in the housing of the device by means of first guide rails mounted on a bottom plate of the device on both sides of an entrance of the housing and second guide rails mounted on the bottom plate of the device on both sides of an exit of the housing and thereby positioning the motor vehicle with respect to image capturing devices which are mounted to holders at a frame of the housing;

detecting the entrance of the motor vehicle into the housing of the device, turning on at least one lighting means, and activating the plurality of image capturing devices;

simultaneously capturing at least one image of at least a top side, a front side, a rear side, a left side and a right side of the motor vehicle in the housing of the device in each case by means of the plurality of image capturing devices, which are divided into a plurality of groups;

storing the captured images of at least the top side, the front side, the rear side, the left side and the right side of the motor vehicle or storing the captured images of at least the top side, the front side, the rear side, the left side and the right side of the motor vehicle and comparing the newly sorted and captured images with already stored images of the motor vehicle; and

creating a report based on the inspection of the stored and newly captured images of the at least top side, front side, rear side, left side and right side of the motor vehicle or based on the comparison between the stored and newly captured images of the at least top side, front side, rear side, left side and right side of the motor vehicle and the stored images of the motor vehicle.

A further object of the invention is to provide a computer program product with which it is possible in the most automated and standardized manner to detect the state of a motor vehicle and to compare it accordingly with states of an earlier time, which are stored in a database or have been recorded at an earlier time.

This object is achieved by a computer program product, the computer program product being provided on a non-transitory and computer-readable medium and causing a computer for a device for inspecting motor vehicles to obtain data from the motor vehicle to be inspected by means of the device, wherein the computer program product being configured to carry out the following steps:

detecting an identification of the motor vehicle to be inspected at an entrance control of a housing of the device and comparing the identification with the identifications stored in a database assigned to the computer;

releasing an entry of the motor vehicle to be inspected into the housing of the device, if the detected identification matches one of the stored identifications;

capturing at least a top side, a front side, a rear side, a left side and a right side of the motor vehicle in the device by means of a plurality of image capturing devices, which are divided into a plurality of groups and mounted at a frame of the housing by holders for the image capturing devices;

transmitting at least the captured images to the computer, and the computer retrieving a data record of images from the database, wherein the data record is assigned to the currently inspected motor vehicle, and the computer compares or stores the data record of the images with the currently captured images of the motor vehicle; and

issuing a report for comparison and storing the report in the database.

The invention has the advantage that the motor vehicles are fully optically, automatically inspected for possible damages. The advantage of the device according to the invention is that images of the state of a motor vehicle can be captured with a standardized and consistent image quality (sharpness and illumination). The motor vehicles may be, for example, returns of leased vehicles, returned rental cars, vehicles of a fleet, vehicles leaving the production line, vehicles to be delivered after transportation at a delivery location, and so on. These vehicles can thus be inspected reliably, of high quality and standardized in a simple, automatic and cost-effective manner Since the state (new state or state from the past) of each motor vehicle, which has an access authorization for the respective device, is or will be stored in a database, it is possible to compare the respectively newly detected state of the motor vehicle with the previous states. Likewise, with the device according to the invention, a data record (image data, etc.) can be created for the first time for a motor vehicle. This is an objective way to document any damage to a vehicle or to already point out possible imminent failure of vehicles in the run-up.

The device according to the invention also provides increased transparency and sustainability with respect to the status of the vehicle. Furthermore, it is possible with the device according to the invention to include standardized service intervals of the corresponding motor vehicles for leasing, service and insurance contracts and the delivery route (for vehicles coming from a production process, loading and unloading of vehicles from train, ship or truck, etc.).

According to a possible embodiment, two parallel markings are provided on the bottom plate. The markings extending from an entrance to an exit of the housing of the device. The motor vehicle can enter the housing on the parallel markings in order to position the motor vehicle in the housing with respect to the image capturing devices.

In a further embodiment, two side walls and a roof are carried by the frame of the housing. At least some holders for the groups of image capturing devices for the top side, the front side, the rear side, the left side and the right side of the motor vehicle are mounted on the frame. The device according to the invention, the holder for a second group of the image capturing device for the underside of the motor vehicle is arranged in the bottom plate between the guide means.

In a particular embodiment of an entrance control is provided for the housing, wherein the image capturing devices of the individual groups and the assigned lighting means are arranged such that images of all sides of the motor vehicle are captured during a passage of the motor vehicle, through the device. A dent is formed in the bottom plate of the device transversely to a longitudinal axis of the device for receiving a means for detecting the state of tires of the motor vehicle.

According to a further particular embodiment an entrance control and an exit control is provided for the housing. The image capturing devices of the individual groups and the assigned lighting means are arranged such that images of all sides of the motor vehicle are captured during a standstill of the motor vehicle in the housing. A dent is formed in the bottom plate of the device transversely to a longitudinal axis of the device for receiving a means for detecting the state of tires of the motor vehicle.

According to a further embodiment of the invention a seventh group of image capturing devices located at the entrance for capturing the rear side of the motor vehicle and an eighth group of image capturing devices is located at the exit for capturing the front side of the motor vehicle.

Sometimes a decisive advantage of the housing is that an effect of the weather conditions and the changing lighting conditions is minimized.

In a further embodiment, an entrance control is provided for a controlled entry of motor vehicles into the device. In this embodiment, the image capturing devices of the individual groups and the assigned lighting means are arranged such that at a passage of the motor vehicle through the device, images of all sides of the motor vehicle can be captured.

According to a further possible embodiment, the device comprises an entrance control and an exit control. The image capturing devices of the individual groups and the assigned lighting means are arranged such that at standstill of the motor vehicle in the device, images of all sides of the motor vehicle can be captured.

In a further possible embodiment, the holder for a second group of the image capturing devices for the image acquisition of the underside of the motor vehicle is arranged in the bottom plate between the guide means.

According to a possible embodiment of the invention, wherein the images captured by the image capturing means are combined into a single image each of the top, underside, front, rear, left and right sides of the motor vehicle. Likewise, from the individual images of the top side, the underside, the front side, the rear side, the left side and the right side of the motor vehicle, a 360° view of the vehicle can be created.

In an embodiment, the image capturing devices are constructed as cameras, with which 3D image acquisition is possible. This has the advantage that the detection or the finding of damages or defects is improved through the 3D images by means of the cameras.

In an embodiment, a dent is inserted in the bottom plate for the floor of the device transversely to a longitudinal axis of the device. The dent serves to receive (accommodate) a means for detecting the state of the tires.

According to a further embodiment, a seventh group of image capturing devices is provided at the entrance. The seventh group serves to capture the rear side of the motor vehicle. Further, an eighth group of image capturing devices may be provided at the exit. The eighth group serves to capture the front side of the motor vehicle. The image capturing devices of the seventh and the eighth group may be constructed as HD cameras. With the HD cameras, for example, the license plate of a motor vehicle can be captured and evaluated for the entrance control.

The image capturing devices of the device may be mounted together with at least one lighting means in holders. The lighting means are arranged in such a way that images can always be captured or generated with the image capturing devices under the same exposure conditions, regardless of the natural illumination. In an alternative embodiment, the lighting means are not mounted together with the image capturing devices in common holders. The only condition is that the lighting means are mounted in such a way that each side of the motor vehicle, no matter at which time it is used for image acquisition in the device, can be illuminated in a standardized manner so that qualitatively equivalent, high-quality and thus comparable images are generated. The advantage is that always the same lighting conditions prevail, which facilitates the inspection and determination of any damage or defects on the vehicle.

The holder for the groups of image capturing devices for the top, underside, rear, left and right sides of the motor vehicle may be mounted on a frame surrounded by the housing. Likewise, the housing itself may consist of a frame which carries two side walls and a roof and has formed the entrance and the exit of the housing. The frame serves to hold the groups of image capturing devices and the at least one lighting means.

Furthermore, in a further embodiment, the underside of the motor vehicle can also be captured. For this purpose, an image capturing device is also mounted in the floor of the device. With this image capturing device, it is possible to capture the underside of the motor vehicle. This image capturing device is also assigned to a lighting means in order to obtain the capturing conditions that are constant and standardized for the image capturing. It is advantageous for the image capturing that the holder for the second group of the image capturing devices for the underside of the motor vehicle is arranged between the guide means. A dent may be introduced in the bottom plate for the floor of the device transversely to the longitudinal axis of the device. A means for detecting the state of tires of the motor vehicle may be seated in the dent. Depending on the customer demands, the means for detecting the state of the tires may be installed in the device. The basic equipment of the device according to the invention is that always image capturing devices are provided to detect all sides of a motor vehicle.

In conjunction with a computer, the inspection of all sides of a motor vehicle is possible, and errors, damage or defects can be easily found and documented.

The bottom plate of the device supports the floor of the device. According to a further possible embodiment, the floor has two dents aligned with the longitudinal axis of the device, which are inserted into the floor at a distance from one another. Each of the dents is covered with a grating. The tires of the motor vehicle roll over the grating during the inspection process or the entrance of the motor vehicle into the device. This has the advantage that any grime and dirt adhering to the vehicle tire may fall off and through to the grating or that moisture or humidity may drip off. The holder for the second group of the image capturing devices for the underside of the motor vehicle is arranged between the two dents.

The image capturing devices of the various groups are communicatively connected to a computer for the evaluation of the data acquired by the image capturing devices with respect to all sides of the motor vehicle. Likewise, according to a further embodiment, the means for detecting the state of the tires may also be communicatively connected to the computer. The computer is assigned to a database in which data on the visual state and the mechanical state of the motor vehicle are stored, so that with respect to the currently captured images of all sides of a motor vehicle, a comparison can be carried out with previously recorded data or the current state data for a new vehicle entered in the database. A particular advantage of the device according to the invention is that with the plurality of cameras, which are divided into the corresponding groups, all sides of a motor vehicle can be captured. Thus, it is possible, for example, in trucks, even in hard to reach places, to obtain images of the state of a motor vehicle, which would be extremely difficult and time consuming to perform with people who need to inspect vehicles. Thus, with the device according to the invention it is easily possible to inspect and possibly determine damages or defects of vehicle components that can be inspected under normal circumstances only by considerable effort, such as roof tarpaulins, luggage roof, roll tarpaulins, tipping troughs, etc.

The method for inspecting motor vehicles is characterized essentially by the fact that, first, an identification of the motor vehicle to be inspected is checked by means of an entrance control. The identification of the motor vehicle to be inspected is stored in a database for the device for inspecting the motor vehicle. In the method, the access authorization for the motor vehicle to be inspected into the device is now checked, and if there is a match, the access for the motor vehicle into the device is released. In case, the device according to the invention is used by a motor vehicle for the first time, it is possible to release the access by hand, or an app, etc., and to enter and store the identification in the database, which is assigned to the device. The release of the entrance control for the motor vehicle may, for example, be by opening a barrier.

The motor vehicle can be substantially centered in the device and positioned with respect to the image capturing devices via a guide means on the bottom of the bottom plate of the device. The entrance of the motor vehicle into the device is detected and at least one lighting means is turned on. The plurality of image capture devices are activated. Light barriers are used to detect the position of the motor vehicle along the longitudinal axis of the device. Depending on the position of the motor vehicle in the device various actions are activated or triggered.

According to a possible embodiment of the invention, once the vehicle is in the device, the top, front, rear, left and right sides of the vehicle are simultaneously captured with the plurality of image capturing devices subdivided into the respective groups. The capture of these images is carried out during the passage of the motor vehicle through the device. The captured images of at least the top, front, rear, left and right sides are compared to stored images of the motor vehicle by means of image processing or, if it is a motor vehicle being in the device for the first time, stored in a suitable manner Finally, a report is made of the comparison between the captured images (image data) and the stored images (image data) of the motor vehicle. For example, it is also possible that damages to the motor vehicle, which were found in the corresponding images, are automatically marked on the overall image of the motor vehicle.

At least one image of an underside of the motor vehicle can be captured with a further group of image capturing devices. The further group of image capturing devices is provided in the bottom plate of the device between the markings.

There are two ways in which the images of a vehicle can be captured with the present invention. A first possibility is that the motor vehicle to be inspected moves through the device for inspecting motor vehicles at a low speed (less than 15 km/h). During the passage of the motor vehicle through the device, images of all sides of the motor vehicle are captured with the image capturing devices of the individual groups.

It is also possible for the motor vehicle to be inspected to enter the device and that the images of the underside, the top side, the front side, the rear side, the left side and the right side are captured when the motor vehicle is at a standstill.

Likewise, the method may also implement the possibility that, according to one embodiment of the invention, the state of the tire is detected. The detection of the state of the tire is carried out during the passage of the motor vehicle through the device or at the exit of the motor vehicle from the device.

The captured images and possibly also detected state of the tire of the motor vehicle are transmitted to a computer. The computer retrieves a data set (image data and alphanumeric data) assigned to the currently inspected vehicle from a database. Also, a comparison of the currently acquired data of the motor vehicle with stored data or with the data of the new vehicle is carried out with the computer.

Furthermore, the image processing implemented in the computer can be constructed in such a way that the images of the top side, the underside, the front side, the rear side, the left side and the right side of the motor vehicle captured by the plurality of image capturing devices are each displayed as a single image of the top side, the underside, the front side, the rear side, the left side or the right side of the motor vehicle.

According to a possible further embodiment of the invention, cameras are used for the image capturing devices with which it is possible to generate 3D images. This has the advantage that damages or defects to the vehicle can be better identified or detected.

The identification of the vehicle to be inspected may, for example, be carried out via a license plate of the motor vehicle, a bar code or by means of an input of identification data of the motor vehicle to a touch display (app) of the device.

A further component of the invention is a computer program product. The computer program product is provided by means of a non-transitory and computer-readable medium. The computer program product causes a computer for the device for inspecting motor vehicles that data (image data and/or status data and/or further readable vehicle data) about the motor vehicle to be inspected are obtained by means of the device. Thus, an identification of the motor vehicle to be inspected is first detected at an entrance control and compared with an identification stored in a database assigned to the computer. If the detected identification matches one of the stored identifications, entry of the motor vehicle to be inspected into the device is enabled. The device comprises a plurality of image capturing devices, which are divided into several groups. By the division into the plural groups, it is thus possible to capture at least a top side, a front side, a rear side, a left side and a right side of the motor vehicle to be inspected. The images are captured during the passage of the motor vehicle through the device or during standstill of the motor vehicle in the device. The captured images are transmitted to a computer. The computer compares the captured images with the data or image data stored in a database. By comparing the collected data with the stored data, a corresponding report is output.

It is also possible with a further embodiment, by means of the device with a means for detecting the state of the tires to detect the current state of the tires during transit through the device or the exit of the motor vehicle from the device. For this purpose, the computer program product is likewise constructed accordingly. Likewise, the collected data on the current state of the tire are also transmitted to the computer. The data on the state of the tire from a previously measured state or the desired data on the state of the tire are stored in a database. The computer now compares the measured or recorded data on the current state of the tire with the data from the database. For this purpose, a corresponding report is also created.

It is also conceivable that the image data is recorded from the top side, the underside, the front side, the rear side, the left side and the right side of the motor vehicle to be inspected with image capturing devices which are constructed as scanners. It is obvious to a person skilled in the art that the image capturing devices are not limited to cameras alone.

In a further embodiment of the invention, sensors already installed in a motor vehicle are used in the device according to the invention. During the inspection of the motor vehicle, data from these sensors are also read out, in order to obtain information about the state or state change of vehicle components.

By means of the device according to the invention, the method according to the invention and the computer program product according to the invention, it is possible to detect the state of a motor vehicle in a simple manner and to generate reports from it. Thus, decision makers receive an objective assessment of the vehicle state and also receive a comparison between a state at an earlier point in time, compared to the current time, in a quick and simple way. Thus, in case of damage can be reacted quickly by this comparison and the chain of evidence as to when the damage occurred is simple and clear. Likewise, it is possible to point out possible damages in advance. The use of image capturing devices that produce 3D images improves the detection of damages or defects to the motor vehicle.

### BRIEF DESCRIPTION OF THE DRAWINGS

Further advantages and advantageous embodiments of the invention are the subject of the following figures, as well as their accompanying parts of the description.

FIG. 1A shows a side view of a schematically illustrated motor vehicle.

FIG. 1B shows a plan view of a schematically illustrated motor vehicle.

FIG. 2 shows a plan view of the floor of the device for inspecting motor vehicles.

FIG. 3 shows a sectional view taken along the line A-A shown in FIG. 2, showing the floor structure of the floor for the device for inspecting motor vehicles according to the present invention.

FIG. 4 shows a plan view of the device for inspecting motor vehicles, wherein additional elements are shown.

FIG. 5 shows a plan view of the device for inspecting motor vehicles according to the present invention, wherein a motor vehicle is already partially retracted into the device for inspecting motor vehicles.

FIG. 6 shows a perspective view of the device for inspecting motor vehicles, wherein a frame is arranged, through which the motor vehicle passes for capturing images.

FIG. 7 shows a view of a group of image capturing devices provided for the underside of the motor vehicle.

FIG. 8 shows a view of a group of image capturing devices provided for capturing images of the left side of the motor vehicle.

FIG. 9 shows a view of a group of image capturing devices provided on the frame for capturing the top side of the motor vehicle.

FIG. 10 shows a schematic assignment of the device for inspecting motor vehicles to a computer and a computer assigned to the database.

FIG. 11 shows a schematic view of the inventive method for inspecting motor vehicles.

FIG. 12 shows a perspective view of a housing open on both sides for the all-round imaging of vehicles.

FIG. 13 shows a side view of a housing, open on both sides, of FIG. 12.

FIG. 14 shows a plan view of a possible embodiment of the construction of the floor surrounded by the housing of FIG. 12,

FIG. 15 shows a plan view of a further possible embodiment of the construction of the floor surrounded by the housing of FIG. 12.

FIG. 16 shows a sectional view of the device and the bottom plate supporting the housing.

FIG. 17 shows a plan view of the bottom plate of the embodiment of the device of FIG. 16.

FIG. 18 shows an interior view of the side wall and the attachment of the image capturing devices.

FIG. 19 shows an inside view of the opposite side wall and the mounting of the image capturing devices.

FIG. 20 shows a schematic view of the arrangement of the image windows of the image capturing devices for capturing one of the side walls of the motor vehicle.

FIG. 21 shows a possible embodiment of the arrangement of the at least one lighting means in the housing.

### DETAILED DESCRIPTION OF THE PREFERRED EMBODIMENTS

Identical reference numerals are used for identical or equivalent elements of the invention. Although the following description describes a device for inspecting motor vehicles that includes, in addition to the image capturing devices, a means for detecting the state of at least one of the tires of a motor vehicle, this should not be construed to limit the invention. It is obvious to a person skilled in the art that the device according to the invention for inspecting a motor vehicle can also be achieved solely by the image capturing devices which capture (record) all sides of a motor vehicle during the passage of the motor vehicle through the device for inspecting the motor vehicle.

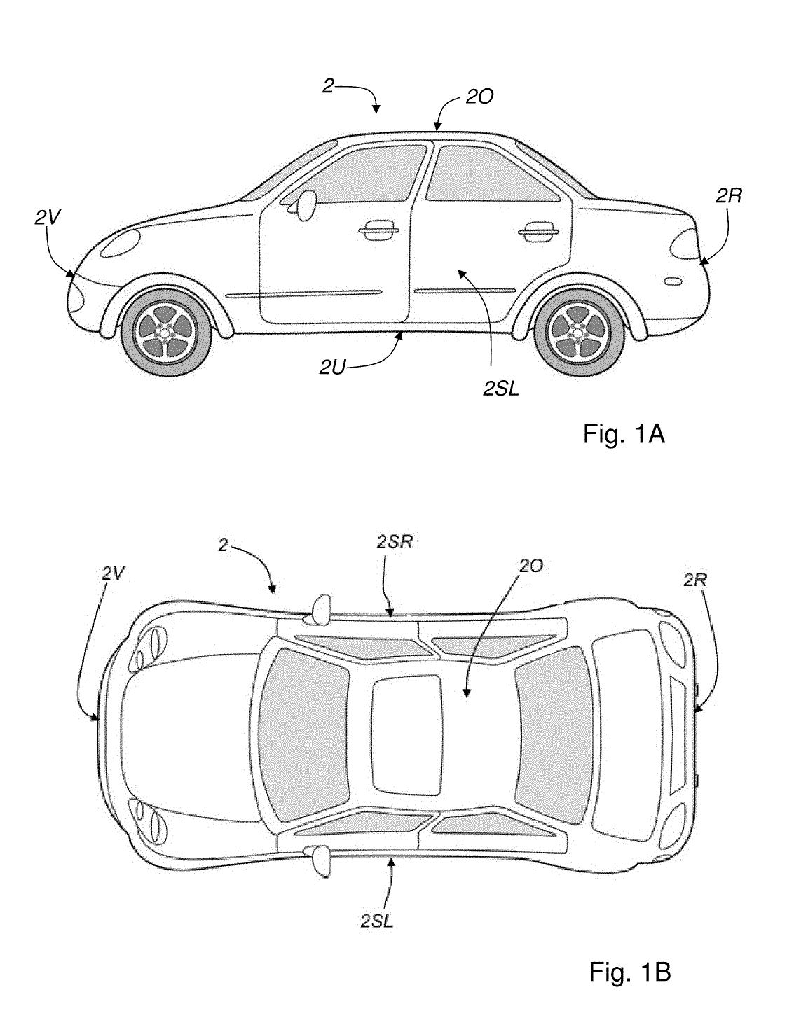

FIG. 1A shows a side view of a motor vehicle 2 shown schematically, and FIG. 1B shows a plan view of the motor vehicle 2. The motor vehicle 2 is defined by a top side 2O an underside 2U, a front side 2V, a rear side 2R, a left side 2SL and a right side 2SR. Although the motor vehicle 2 is shown as a passenger car, this should not be construed as limiting the invention. With a suitable dimensioning of the device 1, images can be captured from the most diverse types of motor vehicle.

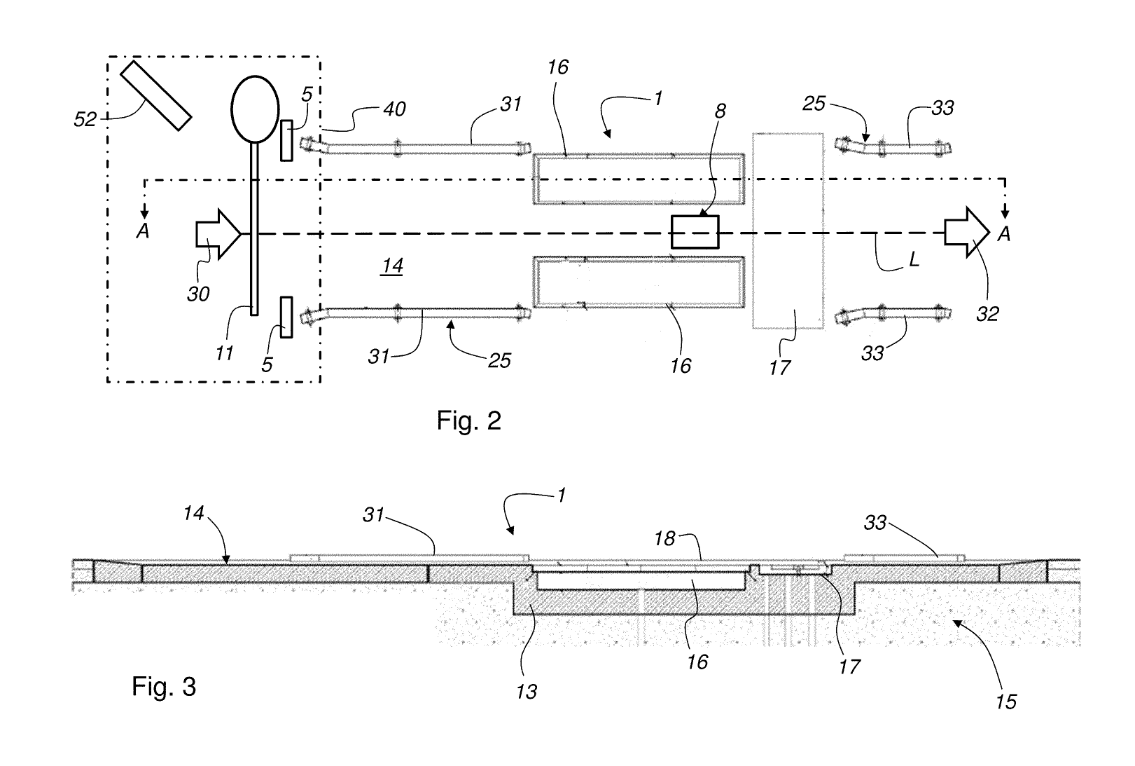

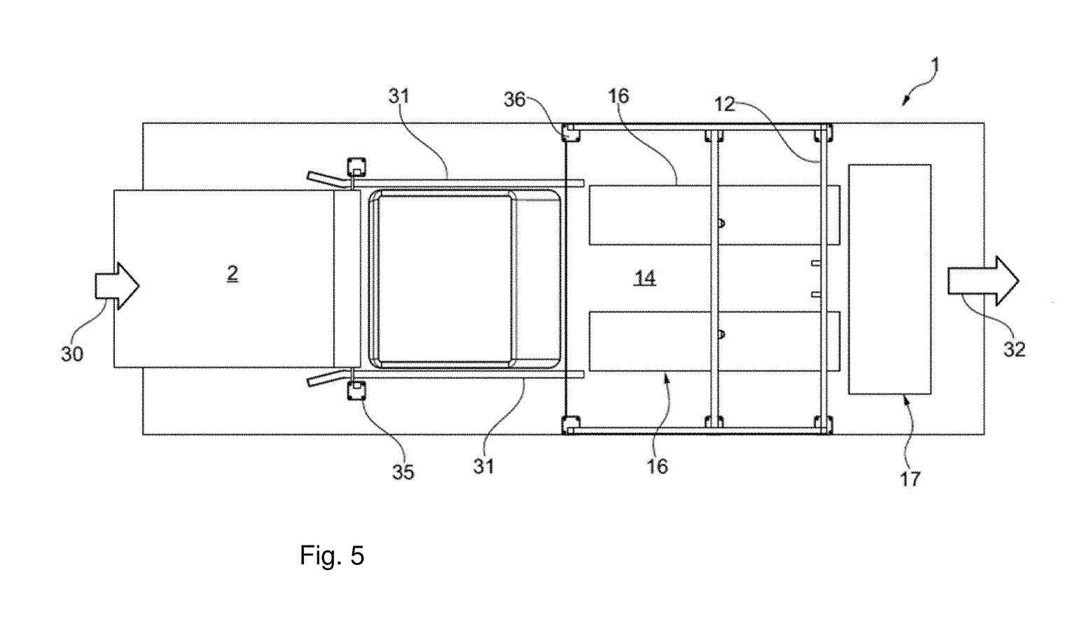

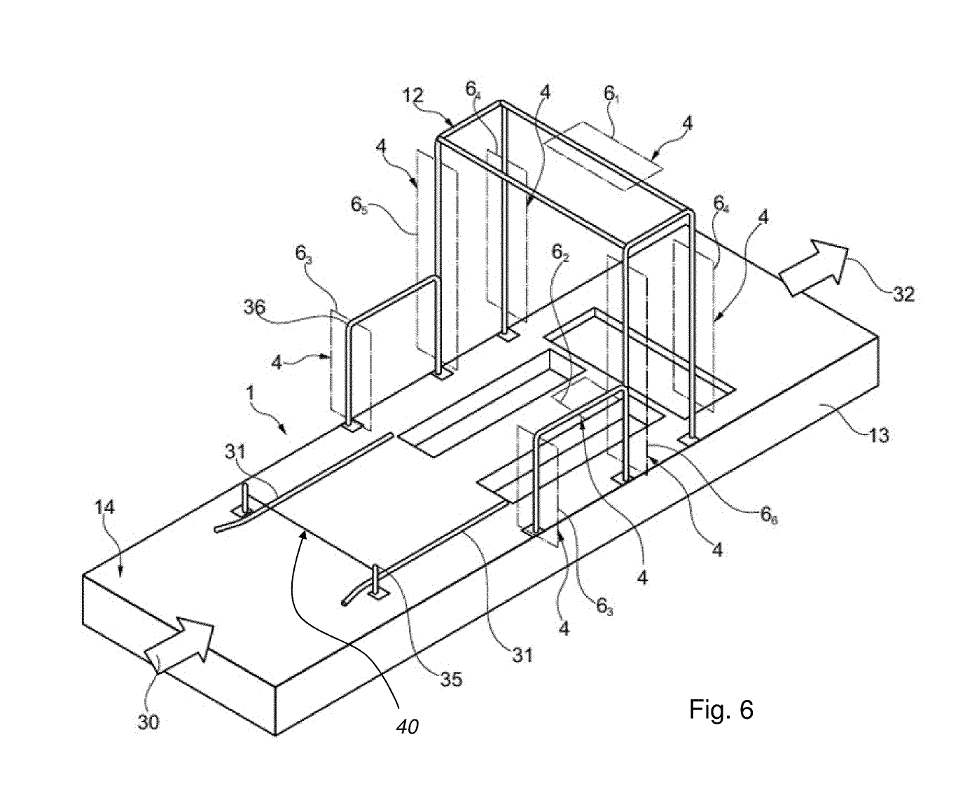

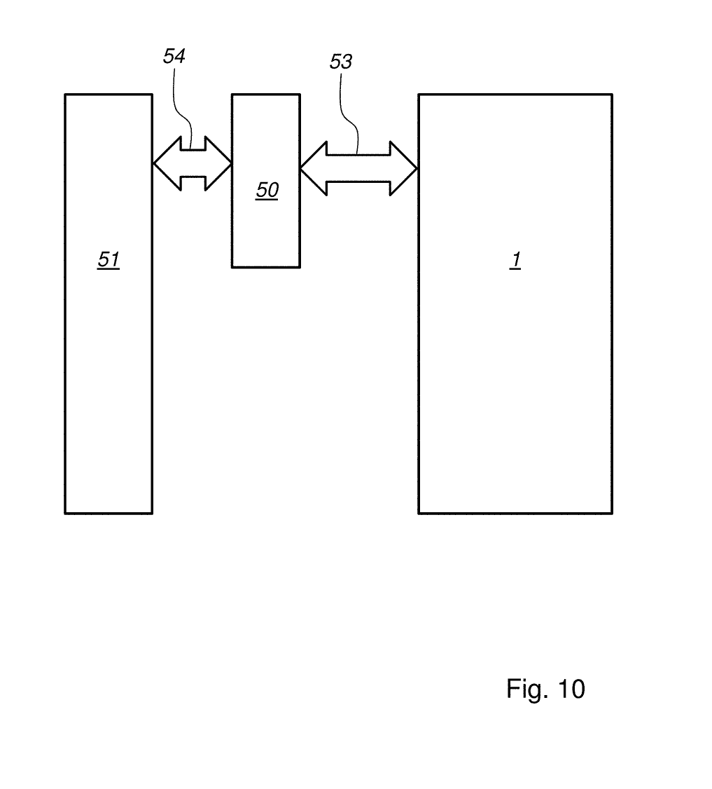

FIG. 2 shows a plan view of a possible embodiment of the device 1 for inspecting motor vehicles 2 (see FIG. 5). In the illustration of the device 1 shown here, however, superstructures or frames 12 (see, for example, FIG. 6) are omitted. On a floor 14 of the device 1 for inspecting motor vehicles 2, the motor vehicles 2 roll through the device 1 during the inspection process. The access to or the entrance into the device 1 is regulated by an entrance control 40. In this embodiment, the entrance control 40 may for example comprise a barrier 11 at an entrance 30, a touch display 52 and at least one camera. In any case, the entrance control 40 comprises at least one barrier 11 which blocks the entrance 30 into the device 1 and receives instruction from a control unit 38 (see FIG. 19). If a motor vehicle 2 approaches the device 1 in order to be inspected with it, an identification of the motor vehicle 2 can be detected. If the identification of the motor vehicle 2 matches with an identification deposited in a database (not shown here), the barrier 11 opens and the motor vehicle 2 can enter the device 1. It is also possible to enter the identification via a touch display 52 so that the access for a motor vehicle 2 to the device 1 is permitted and the barrier 11 opens. If the identification is made based on the license plate of the motor vehicle 2, this can be done with at least one camera 5 (high-resolution camera) and an OCR module of the software in a computer 50 (see FIG. 10).

On the floor 14 of the device 1, a guide means 25 is provided to center the motor vehicle 2 substantially in the device 1 about a longitudinal axis L and to position the motor vehicle 2 with respect to the image capturing devices 4 (image recording devices). In this embodiment, the guide means 25 is defined by means of guide rails 31 and 33. Thus, guide rails 31 are provided on both sides of an entrance 30. Likewise, guide rails 33 are provided on both sides of an exit 32. The guide rails 31, 33 also serve to prevent the motor vehicle 2 from laterally dodging within the device 1 and to possibly damage internal structures or super structures for the inspection of the motor vehicle 2. The motor vehicle 2 is thus intended to move through the device 1 substantially parallel to the longitudinal axis L of the device 1. Two dents 16 are provided parallel to the longitudinal axis L and are covered by a grating 18 (see FIG. 3). The tires of the motor vehicle 2 roll over the grating 18, and thus, dirt or moisture on the tires can drip into the dent 16. Furthermore, a holder 8 may be provided between the two dents 16, in which image capturing devices (not shown here) may be installed for the underside of the motor vehicle 2. Perpendicular to the dents 16, a further dent 17 in the floor 14 of the device 1 is introduced. In the dent 17, a means 20 for detecting the state of the tires of the motor vehicle 2 may be installed.

FIG. 3 shows a cross section through the structure of a bottom plate 13 (base plate) for the floor 14 of the device 1. The bottom plate 13 is seated on a foundation plate 15. In this embodiment, the dent 16 and the dent 17 may be formed in the bottom plate 13 of the floor 14. As already mentioned above, the dent 16 is covered with a grating 18, so that the motor vehicle 2 can roll over the dent 16. The guide rails 31, 33 form the lateral boundary of the device 1.

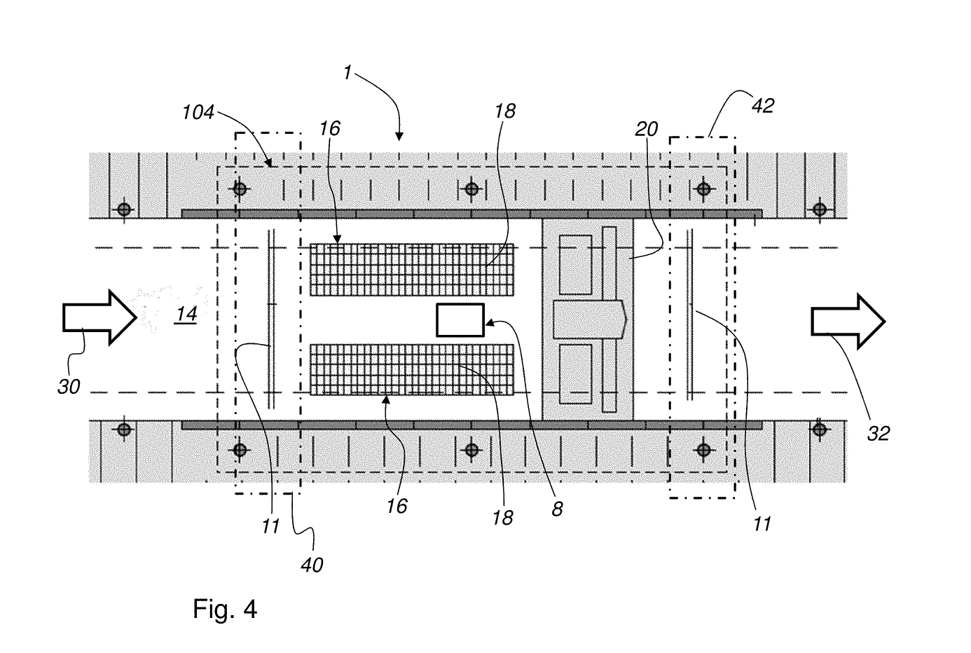

FIG. 4 shows a plan view of a further possible embodiment of the device 1 according to the invention for inspecting motor vehicles 2. The dents 16 with the grating 18, the holder 8 for the image capturing devices 4 of an underside 2U of the motor vehicle 2, and the means 20 for detecting the state of the tires of the motor vehicle 2 are respectively installed in the floor 14. The device 1 is provided with a roof 104 (shown here in dashed lines), which covers the floor 14. The height of the roof 104 above the floor 14 is dimensioned such that both trucks, as well as buses can drive through the device 1. In the event that the device according to the invention is used exclusively for passenger cars, the height of the roof 104 above the floor 14 can be adjusted accordingly. In the illustration shown here, both the entrance 30 and the exit 32 are secured by a respective barrier 11. The barrier 11 at the entrance 30 can be controlled by the entrance control 40, and the barrier 11 at the exit 32 can be controlled by an exit control 42. The exit control 42 is provided in particular in the embodiment of the device 1, in which the images are captured from the individual sides of the motor vehicle 2 during standstill. The exit control 42 may, as shown in FIG. 19, also comprise a monitor 34, on which the driver of the motor vehicle 2 notices about the exit of the device 1 are displayed. Similarly, the entrance control 40 and the exit control 42 may comprise, be assigned to or be connected with photoelectric barriers (not shown).

FIG. 5 shows a schematic plan view of the device 1 according to the invention, in which a motor vehicle 2 is just entering. The roof 104 has been omitted for clarity reasons. The motor vehicle 2 moves between the guide rails 31 of the entrance 30. While driving through the device 1, the motor vehicle 2 passes over the dents 16, which are covered with the grating (not shown here). Here, the embodiment is shown that the motor vehicle 2 moves during the image acquisition by the device 1 with a speed not to be exceeded. The motor vehicle 2 is surrounded by a frame 12 when passing through the device 1. The frame 12 in this embodiment is basically for mounting the image capturing devices 4 (not shown here) to capture images of at least the top side 2O, the left side 2SL, the right side 2SR, the front side 2V, and the rear side 2R of the motor vehicle 2 with the image capturing devices 4. As already mentioned, in one possible embodiment, the means 20 for detecting the state of the tires may be provided in the dent 17 in the floor 14 of the device 1. The state of the tire is also detected when the motor vehicle 2 rolls over the means 20 for detecting the state of the tire of the motor vehicle 2 and thus reaches the exit 32 and leaves the device 1.

FIG. 6 shows a perspective view of the device 1 according to the invention for inspecting motor vehicles 2. On both sides of the entrance 30, the guide rails 31 are provided to drive the motor vehicle 2 through the frame 12 and over the dents 16 and 17. For entrance control 40, a light barrier 35 is provided at the entrance 30 for the motor vehicle 2 in the device 1 in the region of the guide rails 31. Likewise, a light barrier 36 is provided at the beginning of the frame 12, with which also the image capturing devices 4, which are arranged on the frame 12, can be triggered for the capturing the images. The image capturing devices 4 are divided into a plurality of groups 6₁, 6₂, . . . , 6_{N}. Thus, for example, a first group 6₁ of the image capturing devices 4 is assigned to a top side 2O of the motor vehicle 2. A second group 6₂, for example, is assigned to an underside 2U of the motor vehicle 2 and mounted in the holder 8 in the floor 14 of the device 1. With a third group 6₃ of the image capturing devices 4, for example, at least one image of the front side 2V of a motor vehicle 2 can be captured. With a fourth group 6₄, for example, at least one image of a rear side 2R of the motor vehicle 2 can be captured. With a fifth group 6₅, for example, at least one image of the left side 2SL of the motor vehicle 2 can be captured during transit through the device 1. With a sixth group 6₆, for example, at least one image of the right side 2SR of the motor vehicle 2 can be captured while passing through the device 1. The number of groups 6₁, 6₂, . . . , 6_{N} of the image capturing devices 4 should not be construed as limiting the invention. The description of FIG. 6 describes the maximum expansion stage of the device 1, which allows to capture images of all six sides of a motor vehicle 2.

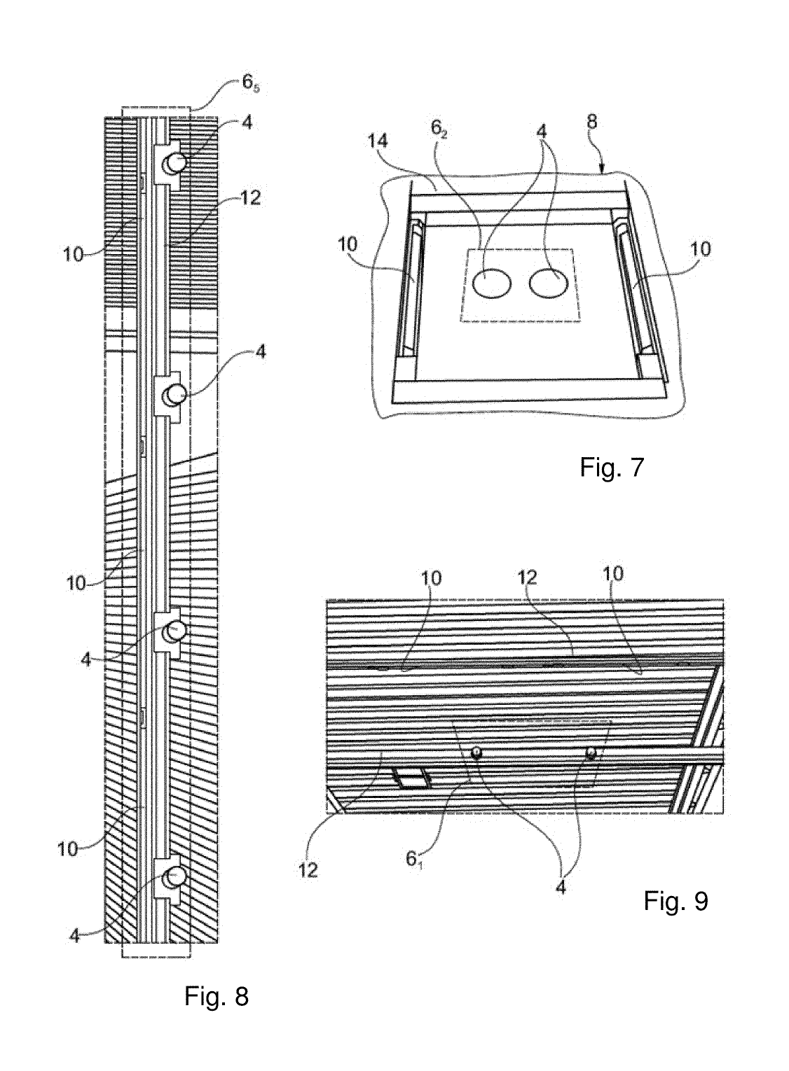

FIG. 7 shows a perspective view of a holder 8 in the floor 14 of the device 1 for capturing images of the underside 2U of the motor vehicle 2. In the illustration shown here, two image capturing devices 4 are provided, which form the second group 6₂ for capturing images of the underside 2U of the motor vehicle 2. Likewise, two lighting means 10 are provided in the holder 8, which serve to illuminate the underside of the motor vehicle 2. The lighting means 10 are important in order to achieve defined lighting conditions at the underside 2U of the motor vehicle 2.

FIG. 8 shows by way of example a perspective view of the fifth group 6₅ of the image capturing devices 4 for capturing images of, for example, the left side 2SL of a motor vehicle 2. The image capturing devices 4 of the fifth group 6₅ are disposed on a part of the frame 12. In this embodiment, a plurality of lighting means 10 may be mounted on the frame 12 to provide optimal and constant illumination of the left side 2SL of the motor vehicle 2. It is obvious to a person skilled in the art that likewise for capturing images of the top side 2O, the right side 2SR, the front side 2V and the rear side 2R of the motor vehicle 2, corresponding lighting means 10 are provided, thus achieving constant illumination conditions for the image acquisition of the corresponding sides of the motor vehicle 2.

FIG. 9 shows a possible embodiment of the first group 6₁ for capturing images of the top side 2O of the motor vehicle 2. The first group 6₁ in the embodiment shown in FIG. 8 comprises two image capturing devices 4 which are arranged on the frame 12. Similarly, the first group 6₁ is also assigned to at least one lighting means 10, which may also be mounted to the frame 12.

FIG. 10 shows a schematic representation of the assignment of the computer 50 to the device 1 for inspecting motor vehicles 2. Via a first communication connection 53, data (captured (recorded) images or measured values of the state of the tire, etc.) can be transmitted to the computer 50. It is likewise conceivable for the computer 50 to transmit corresponding control signals (barrier 11 open/closed, activation of lighting means 10, triggering of the image capturing devices 4, opening of the barrier for entry, opening of the barrier for exit, etc.) to the device 1 via the first communication connection 53. A second communication connection 54 is provided between the computer 50 and the database 51. The computer 50 can retrieve data from the database 51 or store data in the database 51 via the second communication connection 54. It will be understood by those skilled in the art that the first communication connection 53 and the second communication connection 54 may be wireless or wired. Likewise, the database 51 may have various configurations, such as, for example, data server, cloud, etc.

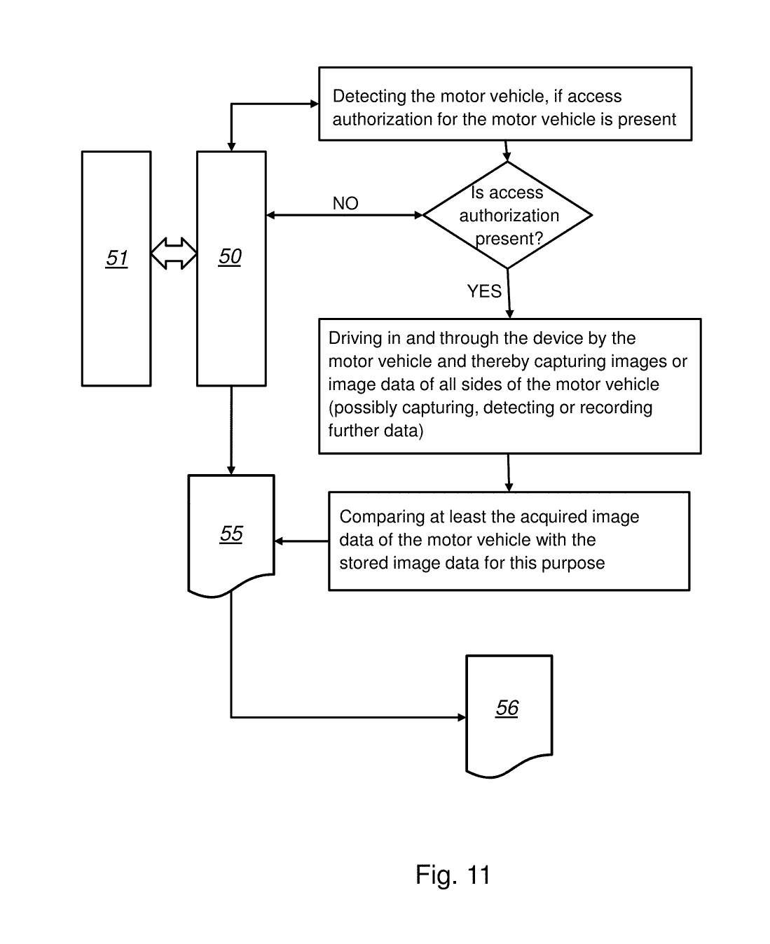

FIG. 11 shows a schematic representation of the steps of the method according to the invention. Here, the embodiment of the method is described that the motor vehicle 2 moves during the image acquisition at a defined speed through the device 1, which defined speed should not exceed a maximum limit. Firstly, an identification of the motor vehicle 2 is carried out with an entrance control (entry control; not shown here). The identification of the motor vehicle 2 is necessary in order to be able to determine whether the motor vehicle 2 is entitled to drive into the device 1 for inspecting motor vehicles 2. There are several possibilities for the identification of the motor vehicle 2. For example, the license plate (number plate) of the motor vehicle 2 may be captured with a camera. By means of an OCR software, the captured license plate can be converted into machine-readable data. This machine-readable data is generated in the computer 50. The computer 50 itself can retrieve in a database, if there is already stored the vehicle with the appropriate license plate. If this is the case, the access authorization is present and, as already mentioned, the barrier 11 opens to the device 1 and the motor vehicle 2 can enter the device 1. If the authorization does not exist, the authorization can also be set manually, for example, entered via a touch display 52, or via an app on a mobile device (smartphone, tablet, etc.). It is also possible to request an authorization from an operator of the device 1 for inspecting motor vehicles 2 and then to transmit this authorization to the database 51.

After issuing the access authorization, the motor vehicle 2 enters the device 1. During the passage of the motor vehicle 2 through the device 1, the corresponding sides of the motor vehicle 2 are captured by the plurality of image capturing devices 4, which are divided into a plurality of groups 6₁, 6₂, . . . , 6_{N}. In one possible embodiment, at least one image of the top side 2O, the underside 2U, the front side 2V, the rear side 2R, the left side 2SL and the right side 2SR of the motor vehicle 2 are captured with the image capturing devices 4 in each case. According to a further embodiment of the invention, further data can also be detected with the device 1 according to the invention. The further data are, for example, data of the state of the tires, data of the detection of fuel level or data of odometer reading (query of mileage (in kilometers)), data from thermal cameras for detecting non-standard heat sources of the vehicle, data of automatic detection of standard deviation, damage detection, flipper-board integration and the query of tasks that are installed on the respective accessories of the motor vehicle 2. In a further step, a comparison 55 of the at least acquired image data of the motor vehicle 2 with the image data stored at an earlier point in time of the motor vehicle 2 is carried out. It is obvious that the comparison 55 is also possible with all other data acquired with the device 1. For the comparison, the computer 51 retrieves from the database 51 the image data stored at an earlier time or other data about the state of the motor vehicle. Finally, a report 56 is created from the comparison 55. The report 56 provides the user of the device 1 for inspecting motor vehicles 2 with clear and irrefutable information about the state of a motor vehicle 2. The report 56 can be used locally or at a remote station. The report 56 may also be stored in the database 51.

The device according to the invention offers a considerable advantage since it allows to determine the state of motor vehicles in an objective manner With the available communication connections, it is thus possible to retrieve the state of the motor vehicle at any location and to draw conclusions about the state and the duration of use of the motor vehicle.

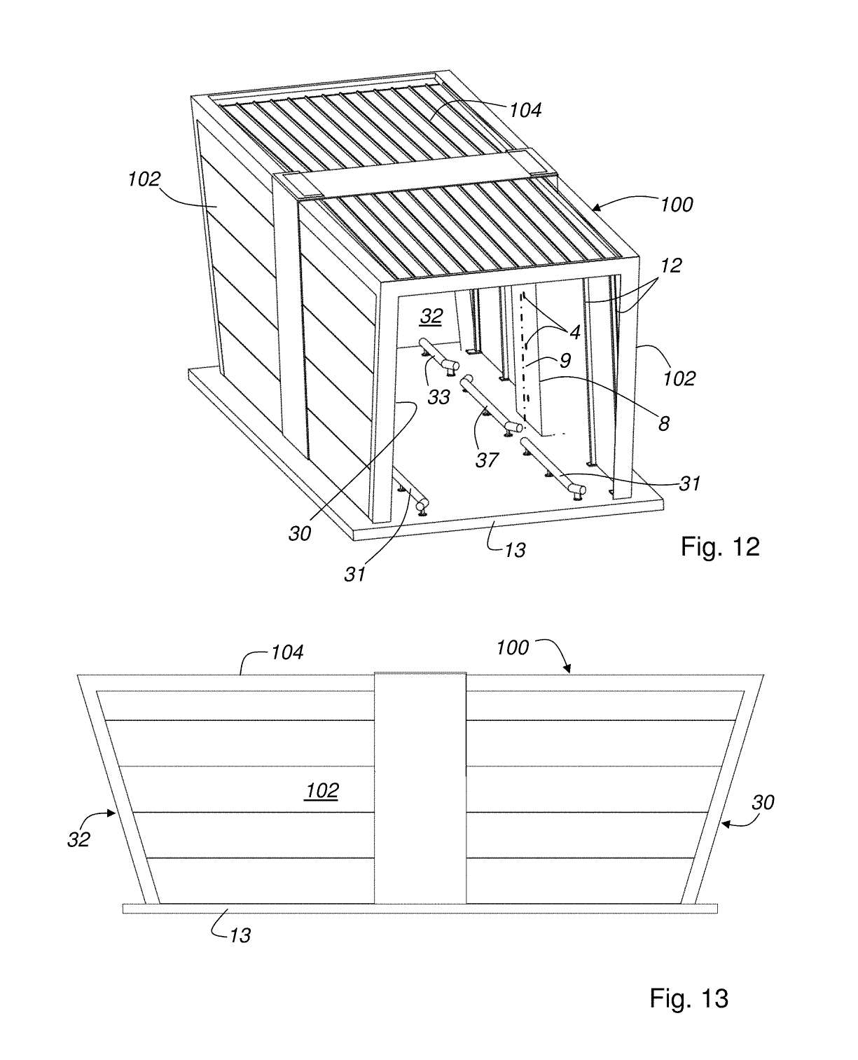

FIG. 12 shows a further possible embodiment of the device 1 according to the invention. The device 1 comprises a housing 100 (enclosure) open on both sides so that images of at least the top side 2O, the front side 2V, the rear side 2R, the left side 2SL and the right side 2SR of the motor vehicle 2 can be captured. The housing 100 is mounted on the bottom plate 13. The housing 100 is mounted to a frame 12 on the bottom plate 13. The frame 12 carries two side walls 102 and a roof 104. The device 1 is accessible to motor vehicles via an entrance 30. The motor vehicles can leave the housing 100 via an exit 32 of the housing 100 or the device 1. In the embodiment of the device 1 illustrated here, a plurality of holders 8 for the groups of image capturing devices 4 are fastened to the frame 12. The image capturing devices 4 for capturing images of the side walls 2SR and 2SL of the motor vehicle 2 are arranged in a line 9 and perpendicular to the bottom plate 13. With this arrangement of the image capturing devices 4, the images of the motor vehicle 2 can be captured during its passage through the device 1.

First guide rails 31 mounted on both sides of the entrance 30 and second guide rails 33 mounted on both sides of an exit 32 serve as a guide means for the motor vehicle 2. Further guide rails 37 may be provided between the first guide rails 31 and the second guide rails 33. The guide rails 31, 33 and 37 form a lateral boundary of the device 1 in order to position the motor vehicle 2 with respect to the image capturing devices 4.

The representation of FIG. 13 is a side view of a housing 100 from FIG. 12 that is open on both sides. The roof 104 of the housing 100 projects beyond the bottom plate 13 in the regions of the entrance 30 and the exit 32. This embodiment has the advantage that weather influences in the interior of the housing 100 can be reduced.

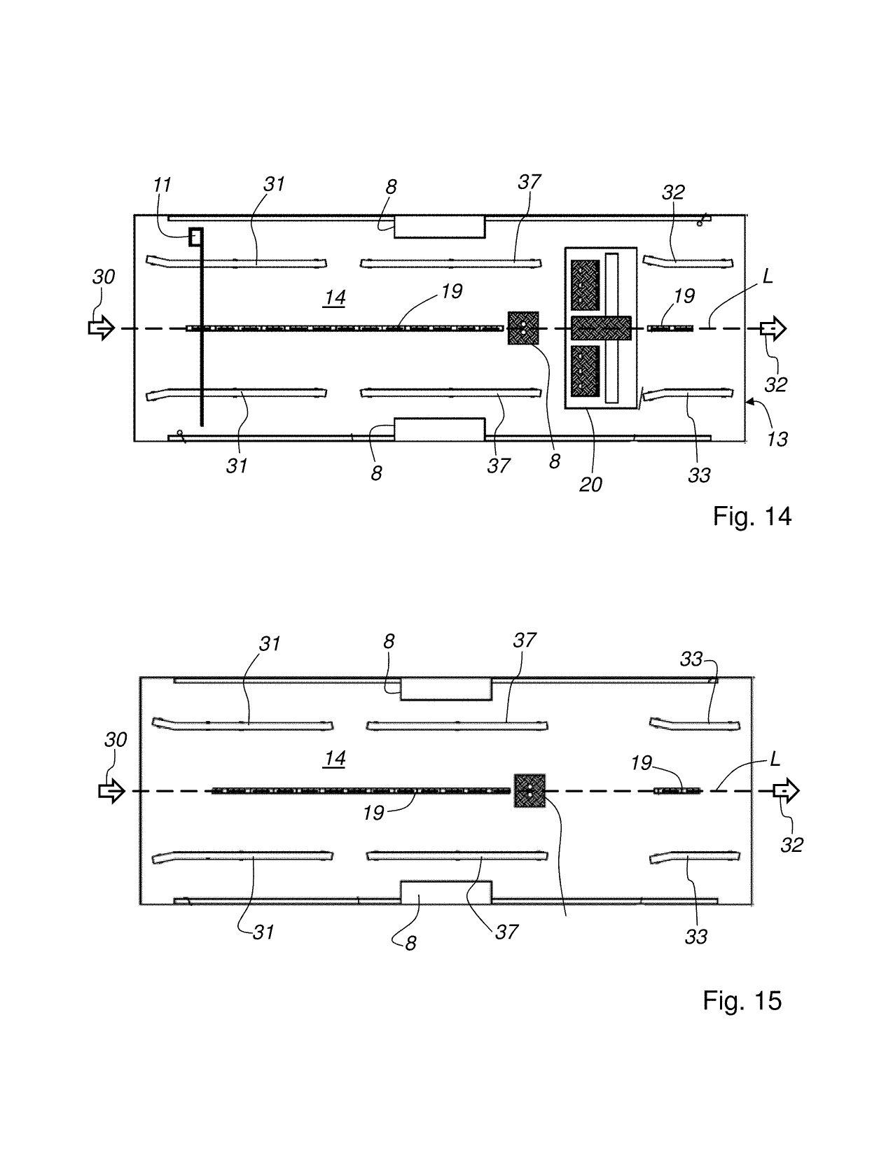

FIGS. 14 and 15 show two different embodiments of the floor 14 of the bottom plate 13 of the device 1. A drain grate 19 (gully grid) may be provided that is arranged in the floor 14 and extends along the longitudinal axis L. Likewise, a holder 8 for image capturing devices 4 for capturing images of the underside 2U of the motor vehicle 2 may be provided and centered about the longitudinal axis L. As already mentioned, the guide rails 31, 33 and 37 center or guide the motor vehicle 2 within the device 1 from the entrance 30 to the exit 32. The embodiment shown in FIG. 14 differs from the embodiment of FIG. 15 in that a means 20 for detecting the state of the tires is provided, wherein the means 20 is transverse to the longitudinal axis L. Further, in FIG. 14, a barrier 11 is provided which releases the entrance into the device 1 if the motor vehicle 2 has an authorization.

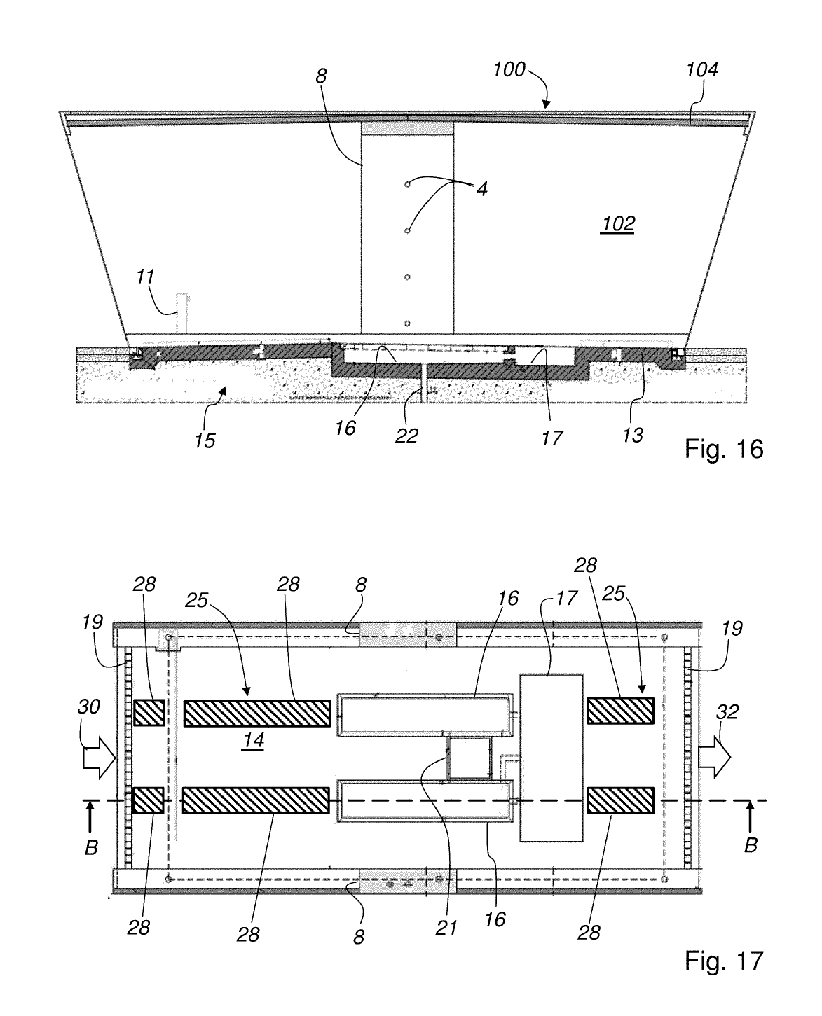

FIG. 16 shows a sectional view of the device 1 along the intersection line labeled B-B in FIG. 17. A holder 8 for the image capturing devices 4 for capturing images of a side 2SR or 2SL of the motor vehicle 2 is provided inside at the side wall 102 of the housing 100. The roof 104 of the housing 100 is inclined so that water can drain. The bottom plate 13 is seated on a foundation plate 15. The dent 16 and the dent 17 for the means 20 (not shown here) for detecting the state of the tire are formed in the bottom plate 13. The dent 17 is fluidly connected to the dent 16. The dent 16 is provided with a drainage 22 for the discharge of water.

As can be seen from FIG. 17, a drain grate 19 is provided in the floor 14 at the entrance 30 and the exit 32 respectively. A dent 21 for the holder 8 (not shown here) of the image capturing devices 4 for capturing images of the underside 2U of a motor vehicle 2 is formed between the dents 16. In the embodiment shown here, the guide means 25 is formed as markings 28 on the floor 14. The motor vehicle 2 should at least enter the device 1 on the markings 28.

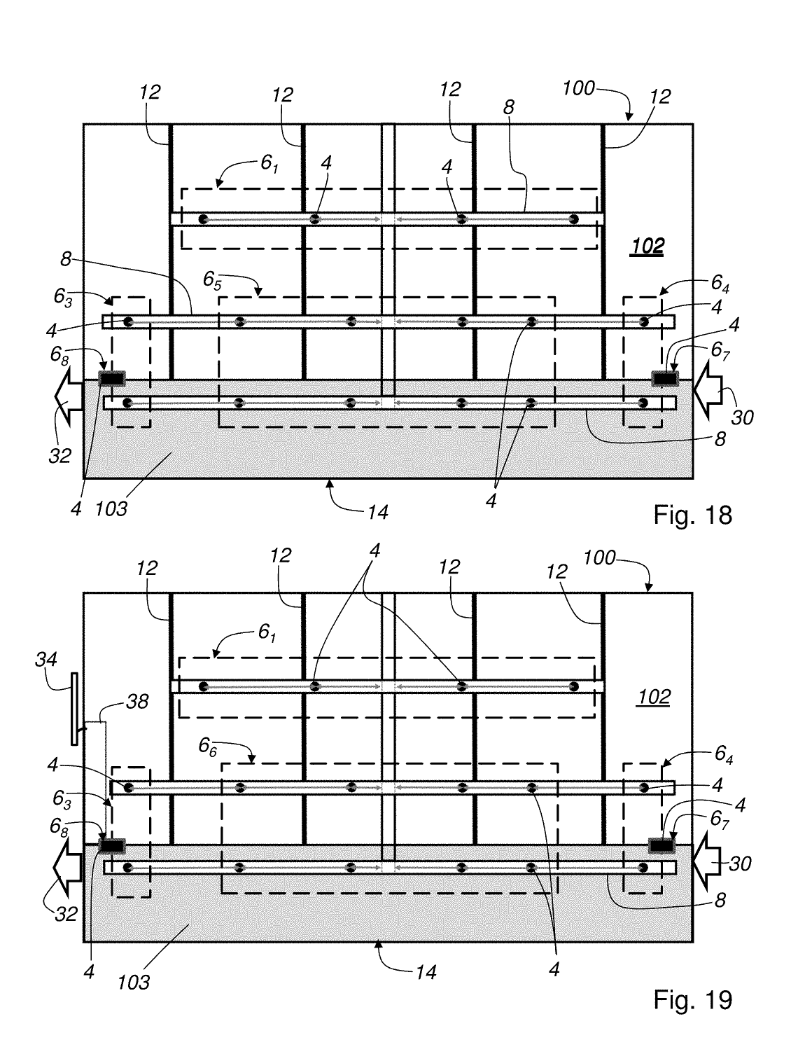

FIGS. 18 and 19 show the arrangement of the image capturing devices 4 on the two opposite side walls 102 of the housing 100. The arrangement of the image capturing devices 4 or their grouping 6₁, 6₂, . . . , 6_{N} shown here is suitable for capturing images of the different sides of the motor vehicle 2, if the motor vehicle 2 is stationary in the device 1 at a predefined position during image acquisition. The first group 6₁ of the image capturing devices 4 for capturing images of the top side 2O of the motor vehicle 2 is provided on the two side walls 102 (see FIGS. 18 and 19). The image capturing devices 4 of the first group 6₁ are mounted with the holder 8 on the frame 12. Similarly, the third group 6₃ of the image capturing devices 4 for capturing images of the front side 2V of a motor vehicle 2 is mounted to the two side walls 102 of the device 1. The fourth group 6₄ of the image capturing devices 4 for capturing images of the rear side 2R of a motor vehicle 2 is mounted to the two side walls 102 of the device 1. The image capturing devices 4 of the fifth group 6₅ for capturing images of the left side 2SL of the motor vehicle 2 are mounted to a side wall 102, and the image capturing devices 4 of the sixth group 6₆ for capturing images of the right side 2SR of the motor vehicle 2 are mounted to the opposite side wall 102.

In the region of the entrance 30, a seventh group 6₇ of image capturing devices 4 for capturing images of the rear side 2R of the motor vehicle 2 is provided on the two side walls 102. Likewise, an eighth group 6₈ of image capturing devices 4 for capturing images of the front side 2V of the motor vehicle 2 are provided at the exit 32. The image capturing devices of the seventh group 6₇ and the eighth group 6₈ are configured as HD cameras. For example, with the HD cameras, at least one image of the license plate or a bar code can be captured so that the authorization for access into the device 1 of the motor vehicle 2 can be granted or denied. The HD cameras of the seventh group 6₇ and the eighth group 6₈ may also be used to capture at least one image of the front side 2V and the rear 2R of the motor vehicle.

As can be seen from FIGS. 18 and 19, the bottom plate 13 is formed such that on the floor 14, two base walls 103 (socle walls, pedestal walls) are formed, on which the frame 12 of the housing 100 is mounted. Also, in the embodiment described here, the fifth group 6₅ and the sixth group 6₆ are arranged such that a holder 8 of the fifth group 6₅ and the sixth group 6₆ is respectively mounted on a base wall 103.

As can be seen from FIG. 19, in this embodiment of the device 1, a monitor 34 can be provided at the exit 32. Here, it is necessary that the motor vehicle 2 stops at a predefined position within the device 1, so that images of all sides of the motor vehicle 2 can be captured. Via the monitor 34, the driver of the motor vehicle 2 can be displayed that the motor vehicle 2 can be driven out of the device 1. Furthermore, the driver of the motor vehicle 2 can be displayed via the monitor 34 that during driving into the device 1 he has reached the predefined position for tape recording. The predefined position may be determined, for example, by means of light barriers (not shown here). A control unit 38 serves to control the device 1.

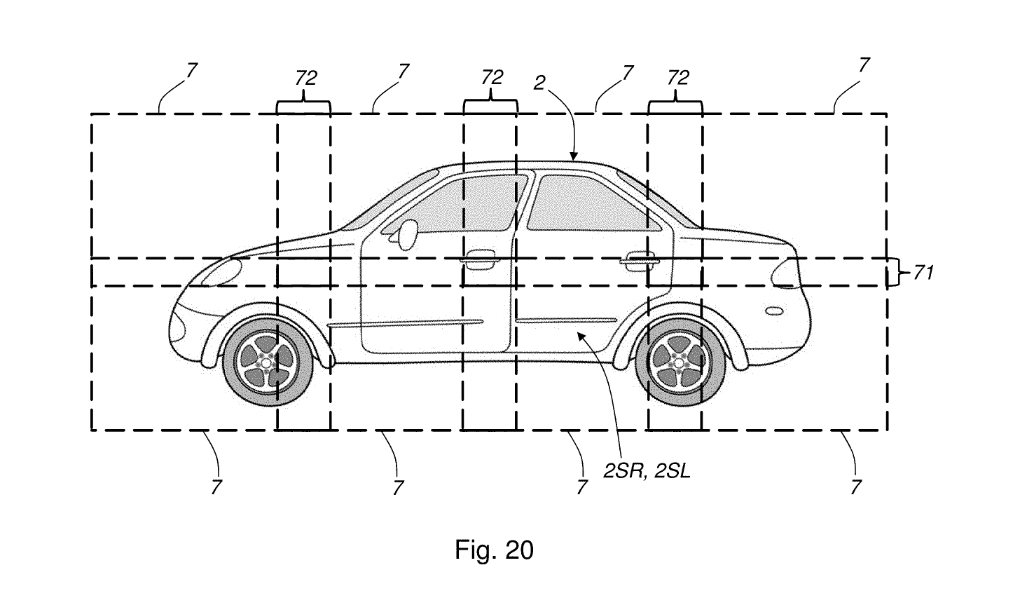

FIG. 20 shows the distribution of the plurality of image windows 7 of the image capturing devices 4 resulting from the arrangement of the image capturing devices 4 in the fifth group 6₅ and the sixth group 6₆ for capturing images of the left side 2SL and the right side 2SR, respectively. In the embodiment described herein, the fifth group 6₅ and the sixth group 6₆ each comprise eight image capturing devices 4. Thus, the right side 2SR and the left side 2SL of the motor vehicle 2 can be captured with eight image windows 7 respectively. The image windows 7 have formed one horizontal overlap area 71 and three vertical overlap areas 72. It will be understood by those skilled in the art that the number of image capturing devices 4 and associated image windows 7 cannot be construed as limiting the invention. From the overlapping image windows 7, a single image of the right side 2SR and/or the left side 2SL of the motor vehicle 2 can be calculated. An analogous process is carried out with all other sides 2O, 2R, 2U, 2V of the motor vehicle 2.

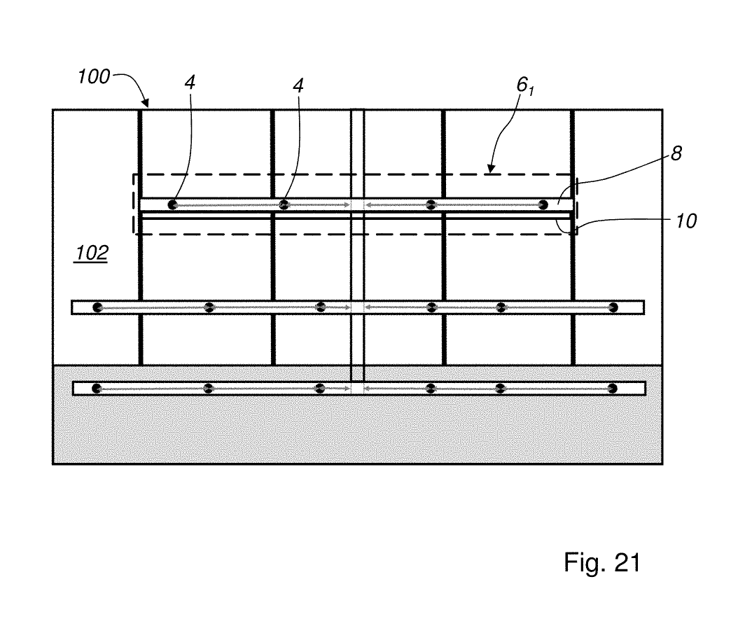

FIG. 21 shows a possible arrangement of the lighting means 10 for illuminating the interior of the housing 100. The lighting means 10 is assigned to the first group 6₁ of the image capturing devices 4 for capturing images of the top side 2O of the motor vehicle 2, provided on the two side walls 102 (see FIGS. 18 and 19) of the housing 100. It obvious that this is only one possible form of arrangement of the lighting means 10.

The invention has been described with reference to a preferred embodiment. However, it will be understood by those skilled in the art that changes and variations may be made without departing from the scope of the following claims.

### LIST OF REFERENCE NUMBERS

1 device
2 motor vehicle
2O top side (upper side)
2R rear side (back side)
2SL left side
2SR right side
2U underside (bottom side, lower side)
2V front side
4 image capturing device
5 camera, high-resolution camera
6₁, 6₂, . . . , 6_{N} group
6₁ first group
6₂ second group
6₃ third group
6₄ fourth group
6₅ fifth group
6₆ sixth group
6₇ seventh group
6₆ eighth group
7 image window
8 holder
9 line
10 lighting means
11 barrier
12 frame
13 bottom plate (base plate)
14 floor
15 foundation plate
16 dent
17 dent
18 grating
19 drain grate (gully grid)
20 means for detecting the state of the tires of the motor vehicle
21 dent
22 drainage
25 guide means
28 marking
30 entrance
31 first guide rail
32 exit
33 second guide rail
34 monitor
35 light barrier
36 light barrier
37 further guide rails
38 control unit
40 entrance control (entry control)
42 exit control
50 computer
51 data base
52 touch display
53 first communication connection
54 second communication connection
55 comparison
56 report
71 horizontal overlap area
72 vertical overlap area
100 housing (enclosure)
102 side wall
103 base wall (socle wall, pedestal wall)
104 roof
A-A intersection line
B-B intersection line
L longitudinal axis

What is claimed is:

1. A device for inspecting motor vehicles, the device comprising:
a bottom plate;
a housing comprising a frame mounted on the bottom plate;
a plurality of image capturing devices mounted to the frame of the housing and being divided into a plurality of groups and being at least arranged such that a top side, a front side, a rear side, a left side, and a right side of the motor vehicle are imaged;
at least one lighting means arranged in the housing with respect to the image capturing devices to provide standardized illumination conditions for the motor vehicles;
first guide rails mounted on the bottom plate, the first guide rails being arranged at both sides of an entrance of the housing; and
second guide rails mounted on the bottom plate, the second guide rails being arranged on both sides of an exit of the housing, the first and the second guide rails forming a lateral boundary of the device in order to center the motor vehicle in the housing and to position the motor vehicle with respect to the image recording devices.

2. The device according to claim 1, wherein two parallel markings are provided on the bottom plate, the markings extending from the entrance to the exit of the housing of the device, and wherein the motor vehicle can enter the housing on the parallel markings in order to position the motor vehicle with respect to the image capturing devices.

3. The device according to claim 1, wherein two side walls and a roof are carried by the frame of the housing and at least some holders for the plurality of groups of the plurality of image capturing devices for the top side, the front side, the rear side, the left side and the right side of the motor vehicle are mounted on the frame.

4. The device according to claim 3, wherein a holder for a second group of the plurality of image capturing device for an underside of the motor vehicle is arranged in the bottom plate between markings on the bottom plate.

5. The device according to claim 1 wherein an entrance control is provided for the housing, wherein the plurality of image capturing devices of the plurality of groups and the at least one lighting means are arranged such that images of all sides of the motor vehicle are captured during a passage of the motor vehicle through the device.

6. The device according to claim 5, wherein a dent is formed in the bottom plate of the device transversely to a longitudinal axis of the device for receiving means for detecting a state of tires of the motor vehicle.

7. The device according to claim 1, wherein an entrance control and an exit control is provided for the housing, the image capturing devices of the individual groups and the assigned lighting means are arranged such that images of all sides of the motor vehicle are captured during a standstill of the motor vehicle in housing.

8. The device according to claim 7, wherein a dent is formed in the bottom plate of the device transversely to a longitudinal axis of the device for receiving a means for detecting the state of tires of the motor vehicle.

9. The device according to claim 1, further comprising a seventh group of image capturing devices located at the entrance for capturing the rear side of the motor vehicle and an eighth group of image capturing devices located at the exit for capturing the front side of the motor vehicle.

10. A method for inspecting a motor vehicle comprising:
checking an identification of the motor vehicle to be inspected and authorizing access of the motor vehicle into a housing of the device when the motor vehicle is registered for access;
substantially centering the motor vehicle in the housing of the device by means of first guide rails mounted on a bottom plate of the device on both sides of an entrance of the housing and second guide rails mounted on the bottom plate of the device on both sides of an exit of the housing, and thereby positioning the motor vehicle with respect to image capturing devices mounted to holders at a frame of the housing;
detecting entry of the motor vehicle into the housing of the device, turning on at least one lighting means, and activating a plurality of image capturing devices;
simultaneously capturing at least one image of at least a top side, a front side, a rear side, a left side and a right side of the motor vehicle in the housing of the device in each case by means of the plurality of image capturing devices which are divided into a plurality of groups;
storing captured images of at least the top side, the front side, the rear side, the left side and the right side of the motor vehicle or storing the captured images of at least the top side, the front side, the rear side, the left side and the right side of the motor vehicle and comparing the captured images with previously stored images of the motor vehicle; and
creating a report based on inspection of the captured images of the at least top side, front side, rear side, left side and right side of the motor vehicle or based on comparison between the captured images of the at least top side, front side, rear side, left side and right side of the motor vehicle and the previously stored images of the motor vehicle.

11. The method of claim 10, further comprising capturing at least one image of an underside (2U) of the motor vehicle by means of a second group of the plurality of image capturing devices, wherein the second group of the plurality of image capturing devices is inserted in the bottom plate of the housing of the device between dents.

12. The method according to claim 11, wherein during a passage of the motor vehicle through the device, images of all sides (2O, 2R, 2SL, 2SR, 2U, 2V) of the motor vehicle are captured by image capturing devices of the groups.

13. The method according to claim 11, wherein at standstill of the motor vehicle in the device images of all sides (2O, 2R, 2SL, 2SR, 2U, 2V) of the motor vehicle are captured by image capturing devices of the groups.

14. The method according to claim 10, wherein a current state of tires of the motor vehicle is detected by a means for detecting the state of the tires of the device.

15. The method according to claim 10, comprising transmitting at least the captured images to a computer, and the computer retrieving a data record of images from a database, wherein a data record is assigned to the motor vehicle, images of the data record are assigned to the computer, and the computer compares or stores the images of the data record with the captured images of the motor vehicle.

16. A computer program product provided on a non-transitory and computer -readable medium and causing a computer for a device for inspecting a motor vehicle to obtain data from the motor vehicle to be inspected by means of the device, the computer program product being configured to carry out the following steps:
detecting an identification of the motor vehicle to be inspected at an entrance control of a housing of the device and comparing the identification with stored identifications in a database assigned to the computer;
authorizing an entry of the motor vehicle into the housing of the device if the identification matches one of the stored identifications;
forming captured images by capturing at least a top side, a front side, a rear side, a left side and a right side of the motor vehicle in the device by means of a plurality of image capturing devices, which are divided into a plurality of groups and mounted at a frame of the housing by holders for the plurality of the image capturing devices;
transmitting at least the captured images to the compute to retrieve a data record of images from the database, wherein the data record is assigned to the motor vehicle, and wherein the computer compares or stores the data record of the images with the captured images of the motor vehicle; and
issuing a report for comparison, and storing the report in the database.

17. The computer program product according to claim 16, further comprising:
detecting a state of the motor vehicle's tires by means for detecting the state of the tires by the device; and
transmitting data on the state of the tires to the computer to retrieve a data set relating to the motor vehicle from the database, to compare the data set with a currently recorded data of the motor vehicle with respect to the state of the tires and to add the data set to the report.

18. The computer program product according to claim 16, further comprising image processing to combine the captured images into a single image for each of the top, under, front, rear, left and right sides of the motor vehicle.

19. A device for inspecting motor vehicles, the device comprising:
a bottom plate;
a housing comprise of a frame mounted on the bottom plate;
image capturing devices mounted to the frame of the housing and being divided into a plurality of groups and being at least arranged such that:
a first group of the image capturing devices images a top side of the motor vehicle,
a second group of the image capturing devices images an underside of the motor vehicle, wherein the image capturing devices are arranged in a bottom plate between guide means,
a third group of the image capturing devices images a front side of the motor vehicle, wherein the image capturing devices are located at an exit of the housing of the device,
a fourth group of the image capturing devices images a rear side of the motor vehicle, wherein the image capturing devices are located at an entrance housing of the housing of the device;
a fifth group of the image capturing devices images a left side of the motor vehicle,
a sixth group of the image capturing devices images a right side of the motor vehicle;
at least one lighting means arranged in the housing with respect to the image capturing devices to provide standardized illumination conditions for the motor vehicle;
first guide rails mounted on the bottom plate so that they are arranged at both sides of an entrance of the housing; and
second guide rails mounted on the bottom plate, so that they are arranged on both sides of an exit of the housing, wherein the first and the second guide rails form a lateral boundary of the device in order to center the motor vehicle in the housing and to position the motor vehicle with respect to the image recording devices.

20. The device as claimed in claim 19, wherein a seventh group of the image capturing devices images the rear side of the motor vehicle and being provided on two side walls of the housing, wherein an eighth group of the image capturing devices images the front side of the motor vehicle and being provided at the exit of the housing, and wherein the seventh group of the image capturing devices and eighth group of the image capturing devices are HD cameras.
